(19) United States
(12) Patent Application Publication
(10) Pub. No.: US 2010/0277504 A1
(43) Pub. Date: Nov. 4, 2010

(54) METHOD AND SYSTEM FOR SERVING THREE DIMENSION WEB MAP SERVICE USING AUGMENTED REALITY

(76) Inventor: Ju Young Song, Seoul (KR)

Correspondence Address: NIXON & VANDERHYE, PC, 901 NORTH GLEBE ROAD, 11TH FLOOR, ARLINGTON, VA, 22203, US

(21) Appl. No.: 12/810,701

(22) PCT Filed: Jun. 29, 2008
(86) PCT No.: PCT/KR08/03781

§ 371 Date: Jun. 25, 2010

(30) Foreign Application Priority Data
Dec. 27, 2007 (KR) 10-2007-0139061

(51) Int. Cl. G09G 5/00

(52) U.S. Cl. 345/633

(57) ABSTRACT

Disclosed is a method for a 3-dimensional (3D) web map service using augmented reality, the method including downloading a mapping information file where 2-dimensional (2D) marker information and 3D modeling data are mapped, receiving map data including the 2D marker information from a map data providing server, rendering a map to a frame buffer in advance using the received map data, extracting an identification (ID) of the 3D modeling data through detecting 2D marker information from the map data and searching the mapping information file, extracting the 3D modeling data corresponding to the detected 2D marker information from a 3D modeling database using the ID of the 3D modeling data, additionally rendering the 3D modeling data to the frame buffer after processing the 3D modeling data, and rendering the rendered data to a screen.

### TECHNICAL FIELD

The present invention relates to a method for a 3-dimensional (3D) web map service using augmented reality and a system thereof, and particularly, to a method and system for a 3D web map service which can perform mapping of 2-dimensional (2D) marker information expressible with a small amount of data with a specific 3D object in advance, receive only 2D marker information corresponding to a location where the 3D object to be drawn without receiving the entire 3D object when receiving map data in real time, render 3D modeling data corresponding to the 2D marker information, and thereby can provide 3D map service.

### BACKGROUND ART

In general, an augmented reality system is virtual reality technology that shows a real world that a user sees with eyes and a virtual world that has additional information as a single feature, which is a Hybrid Virtual Reality System that combines the real environment with the virtual environment. The augmented reality is a concept that the real world is combined with the virtual world. Although the augmented reality uses the virtual environment made by computer graphics, a main part is the real environment. The computer graphics additionally provide information needed by the real environment and enables the 3-dimensional (3D) virtual image to be overlapped with a real image that the user sees, and thus separation between the real world and the virtual image is unclear.

That is, to composite the virtual image to the real image, the augmented reality system processes 3D modeling data using a 3D perspective projection giving an effect as if a real camera projects the real image, the 3D modeling data being created based on a location of a camera and a posture value in advance, renders the virtual image, and then composites and displays the real image and the virtual graphic. In this instance, in order to composite a virtual graphic object to an accurate location of the real image, the augmented reality system is required to perform a registration that verifies an accurate location and direction of virtual objects on a 2-dimensional (2D) screen. To perform the registration, 3D coordinates of a certain point (e.g., a location where a virtual object is to be drawn) in a real world are required, and the coordinates are required to be coordinate values based on the camera.

Accordingly, the virtual augmented system needs to obtain counterpart 3D coordinates with respect to a certain point or object of the real world. Theoretically, two cameras are required to obtain the 3D coordinates based on a principle that a human being recognizes a depth through two eyes. However, usually a single camera is used and since it is hard for the single camera to recognize a 3D location in the real world, a marker is used.

The marker represents a certain object that is recognizable to a computer vision technique. As an example, the marker is a plane pattern directly written in a black ground or a geometrical object with a unique color. How the virtual object is seen from a visual point of the camera and a given 3D location and how to be drawn is determined by a projection calculation.

To apply this principle to a 3D web map service, a great amount of data, such as information for hundreds to thousands of points, texture information, corresponding texture image, and the like, is required to express a general 3D object. Also, all of the information is required to be transmitted to a network to express the 3D object to a user in the web map service. However, a 3D web map service scheme has a significantly higher load when performing network transmission of data compared with a rendering time, and thus providing a service in real time is almost impossible.

However, although a problem of storing the 3D objects in a user computer in advance or transmitting the great amount of data through use of caching every time is solved, it is extremely difficult to draw the previously stored objects at an accurate location on the map, since a direction and declination of the map are required to be varied according to an user input in the 3D web map service.

Accordingly, a method to solve the problem of the 3D web map service is absolutely required.

### DISCLOSURE OF INVENTION

### Technical Goals

An aspect of the present invention provides a method and system for a 3-dimensional (3D) web map service which can perform mapping of 2-dimensional (2D) marker information expressible with a small amount of data with a specific 3D object in advance, receive only 2D marker information corresponding to a location where the 3D object to be drawn without receiving the entire 3D object when receiving map data in real time, render 3D modeling data corresponding to the 2D marker information, and thereby can provide 3D map service.

### Technical Solutions

According to an aspect of the present invention, there is provided a method for a 3-dimensional (3D) web map service using augmented reality, the method including downloading a mapping information file where 2-dimensional (2D) marker information and 3D modeling data are mapped, receiving map data including the 2D marker information from a map data providing server, rendering a map to a frame buffer in advance using the received map data, extracting an identification (ID) of the 3D modeling data through detecting 2D marker information from the map data and searching the mapping information file, extracting the 3D modeling data corresponding to the detected 2D marker information from a 3D modeling database using the ID of the 3D modeling data, additionally rendering the 3D modeling data to the frame buffer after processing the 3D modeling data, and rendering the rendered data to a screen.

According to another aspect of the present invention, there is provided a 3D web map service system, the system including a 3D modeling database to store a mapping information file where 2D marker information and 3D modeling data are mapped, a receiving unit to receive map data including 2D marker information from a map data providing server, an extractor to extract an ID of the 3D modeling data through detecting 2D marker information from the map data and searching the mapping information file, and to extract the 3D modeling data corresponding to the 2D marker information detected from the 3D modeling database using the ID of the 3D modeling data, and a rendering unit to render a map to a frame buffer using the map data in advance, process the 3D modeling data, and additionally render the 3D modeling data to the frame buffer.

### Advantageous Effect

According to example embodiments, a method and system for a 3D web map service which can perform mapping 2D marker information expressible with a small amount of data with a specific 3D object in advance, receive only 2D marker information corresponding to a location where the 3D object to be drawn without receiving the entire 3D object when receiving map data in real time, render 3D modeling data corresponding to the 2D marker information, and thereby can provide 3D map service.

### BRIEF DESCRIPTION OF DRAWINGS

FIG. 1 illustrates an interworking relation between a 3-dimensional (3D) web map service system using an augmented reality and a map data providing server according to the present invention;

FIG. 2 illustrates a configuration of a 3D web map service system using augmented reality according to an example embodiment of the present invention;

FIG. 3 illustrates an example of 2-dimensional (2D) marker information;

FIG. 4 illustrates an example of 3D modeling data;

FIG. 5 illustrates an example of a mapping relation between a 2D marker information and 3D modeling data;

FIG. 6 illustrates an example of a mapping information file where an identification (ID) of 2D marker information and an ID of a 3D modeling data are mapped;

FIG. 7 illustrates an example of a composite state of 2D marker information and 3D modeling data mapped to the 2D marker information;

FIG. 8 is a flowchart illustrating a method for 3D web map service using augmented reality according to an example embodiment of the present invention; and

FIG. 9 illustrates an example that embodies an operation of extracting an ID of 3D modeling data through detecting 2D marker information and searching mapping information file.

### BEST MODE FOR CARRYING OUT THE INVENTION

Hereinafter, a method and system for a 3-dimensional (3D) web map service using augmented reality will be described referring to attached drawings.

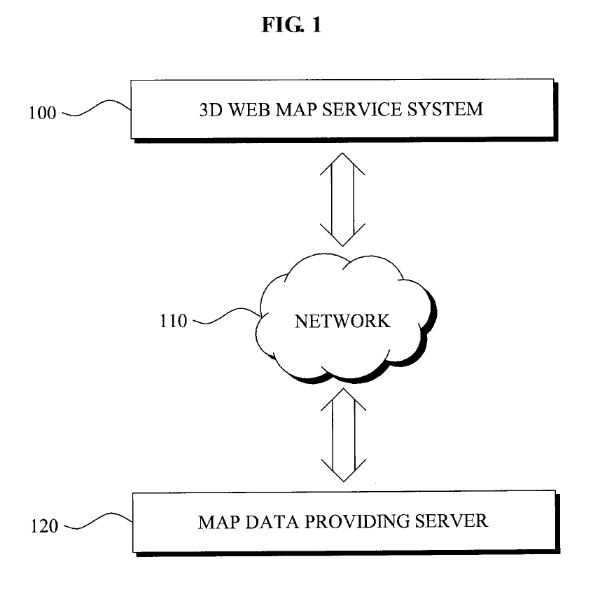

FIG. 1 illustrates an interworking relation between a 3D web map service system using an augmented reality and a map data providing server according to the present invention.

Referring to FIG. 1, a 3D web map service system 100 downloads a mapping information file where 2D marker information and 3D modeling data are mapped, in advance.

Also, the 3D web map service system 100 receives map data including 2D marker information from a map data providing server 120 interworking through a network 110.

The 3D web map service system 100 renders a map to a frame buffer using the received map data, detects 2D marker information from the map data, and searches the map information file to extract identification (ID) of the 3D modeling data. Also, the 3D web map service system 100 extracts the 3D modeling data corresponding to the detected 2D marker information from a 3D modeling database using the extracted ID of the 3D modeling data.

The 3D web map service system 100 processes the extracted 3D modeling data, additionally renders the 3D modeling data to the frame buffer, and renders a rendered data to a screen.

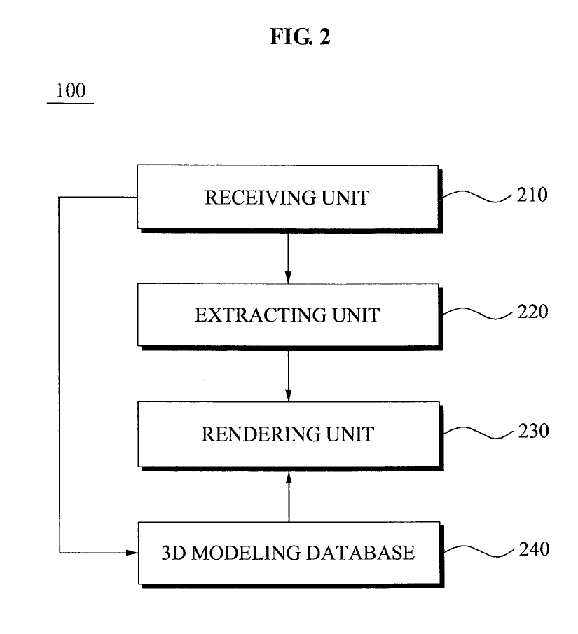

FIG. 2 illustrates a configuration of a 3D web map service system using augmented reality according to an example embodiment of the present invention.

Referring to FIG. 2, a 3D web map service system 100 includes a receiving unit 210, extracting unit 220, rendering unit 230, and 3D modeling database 240.

The receiving unit 210 receives map data including 2D marker information from a map data providing server 120 interworking through a network 110.

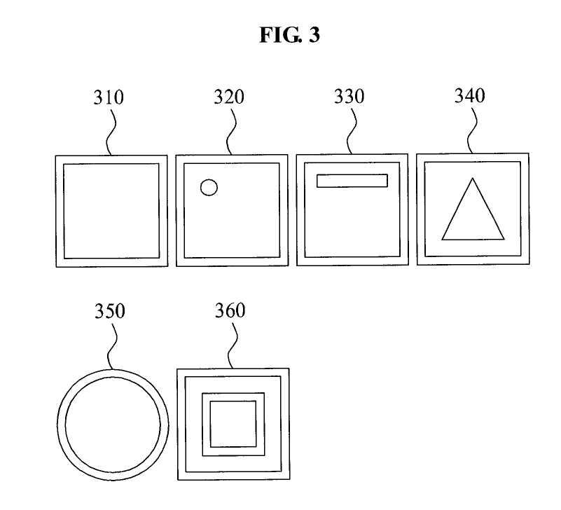

FIG. 3 illustrates an example of 2D marker information.

Referring to FIG. 3, 2D marker information 310 to 340 according to the present invention may inversely calculate a direction and distance, and every figure having a single pattern in every direction may be used as the 2D marker information. However, since marker information 350 and 360 may not inversely calculate the direction and distance, they may not be used as the 2D marker information according to the present invention.

Also, a receiving unit 210 may receive a mapping information file where the 2D marker information and a 3D modeling data are mapped.

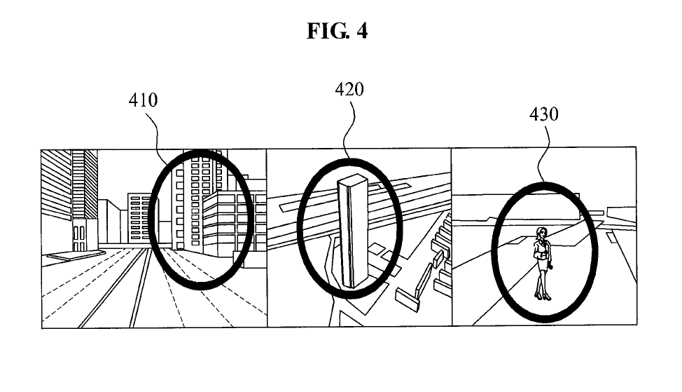

FIG. 4 illustrates an example of 3D modeling data.

Referring to FIG. 4, 3D modeling data 410 to 430 represent all data used for rendering a game or 3D rendering, which may include data produced by ACE, X file, or 3D Max, and data used in Quake, such as MD3, and the like.

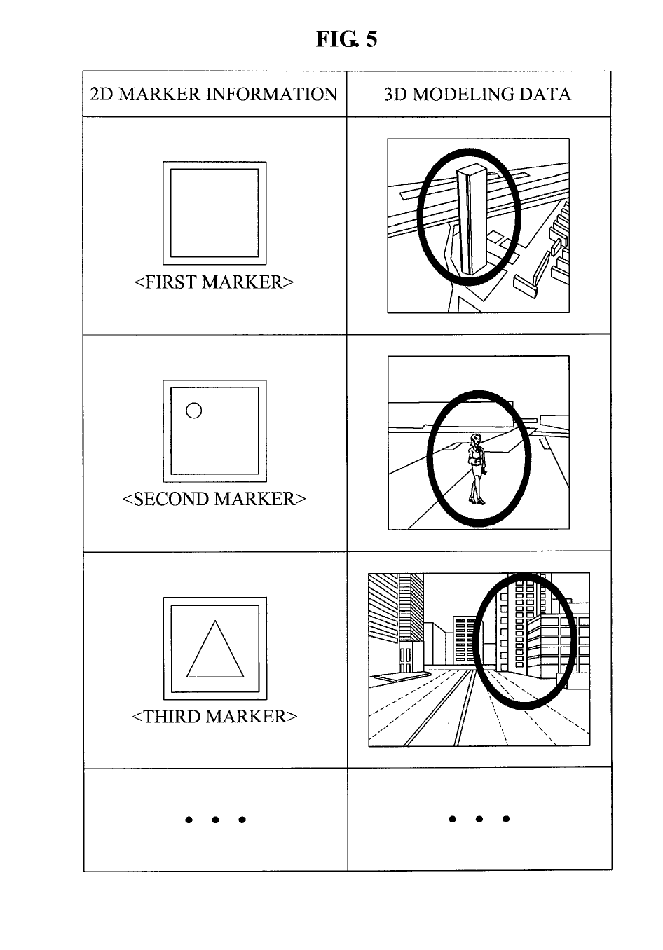

FIG. 5 illustrates an example of a mapping relation between a 2D marker information and 3D modeling data.

Referring to FIG. 5, a first marker, which is a square, is matched with 3D modeling data of 63 Building, a second marker, which is a square including a circle, is matched with 3D modeling data of a woman character object, a third marker, which is a square comprised of triangles, is matched with 3D modeling data of Hankook Cosmetics Building. As described above, the 2D marker information and 3D modeling data are one-to-one matched.

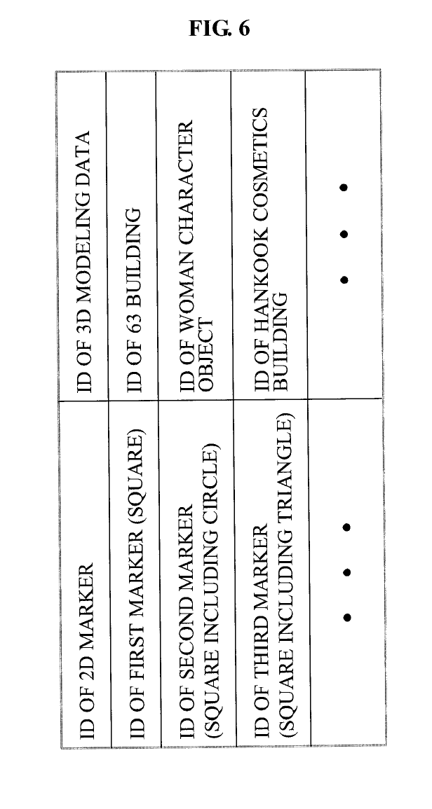

FIG. 6 illustrates an example of a mapping information file where an ID of 2D marker information and an ID of a 3D modeling data are mapped.

Referring to FIG. 6, the ID of the 2D marker information and the ID of the 3D modeling data are mapped one-to-one in the mapping information file. An ID of a first marker, which is a square, is mapped to an ID of 63 Building, an ID of a second marker, which is a square including a circle, is mapped to an ID of 3D modeling data of a woman character object, and an ID of a third marker, which is a square including a triangle, is mapped to an ID of Hankook Cosmetics Building.

An extractor 220 detects the 2D marker information from map data, searches the mapping information file, and extracts the ID of the 3D modeling data. Also, the extractor 220 extracts the 3D modeling data corresponding to the detected 2D marker information from a 3D modeling database 240 using the ID of the 3D modeling data. That is, the extractor 220 detects whether marker information which is the same as the 2D marker information included in the mapping information file exists in a frame buffer through analyzing the frame buffer and being subjected to an image processing, and extracts the 3D modeling data corresponding to the detected marker information from a 3D modeling database through searching the mapping information file.

A rendering unit 230 renders a map to the frame buffer in advance using the map data, processes the 3D modeling data, and additionally renders the 3D modeling data to the frame buffer.

A 3D modeling database 240 performs downloading of the 3D modeling data in advance and stores the mapping file information where the 2D marker information and the 3D modeling data are mapped as illustrated in FIG. 6.

That is, the rendering unit 230 renders the extracted 3D modeling data to a predetermined location through adjusting a size and rotation direction according to a distortion degree of a marker on the map, and renders the rendered data to a screen.

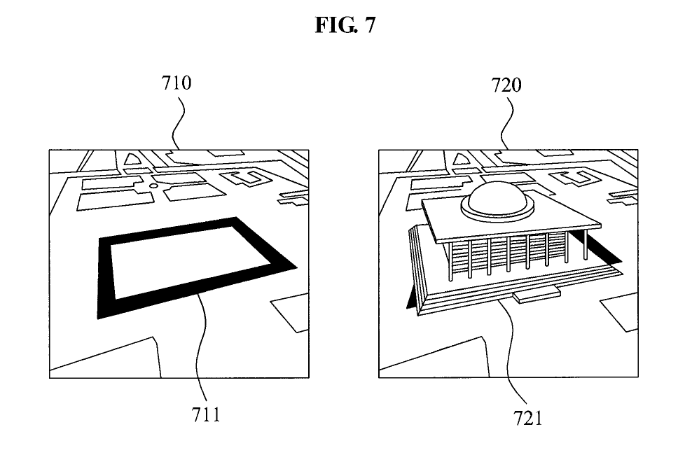

FIG. 7 illustrates an example of a composite state of 2D marker information and 3D modeling data mapped to the 2D marker information.

Referring to FIG. 7, 2D map data 710 includes the 2D marker information 711, and 3D map data 720 is a composite state of the 2D marker information and 3D modeling data 721 mapped to the 2D marker information. An extractor 220 detects whether marker information which is the same as the 2D marker information 711 included in the mapping information file exists in a frame buffer through analyzing the frame buffer and being subjected to an image processing, and extracts the 3D modeling data 721 corresponding to the detected marker information from a 3D modeling database 240 through searching the mapping information file. Also, a rendering unit 230 renders the extracted 3D modeling data 721 to a predetermined location through adjusting a size and rotation direction according to a distortion degree of a marker on the map, and renders a rendering result, namely, 3D map data, to a screen.

As described above, the 3D map web service system 100 according to the present invention may perform mapping of 2D marker information expressible with a small amount of data to a specific 3D object in advance, receive only 2D marker information corresponding to a location where the 3D object to be drawn without receiving the entire 3D object when receiving map data in real time, render 3D modeling data corresponding to the 2D marker information, and thereby can provide 3D map service.

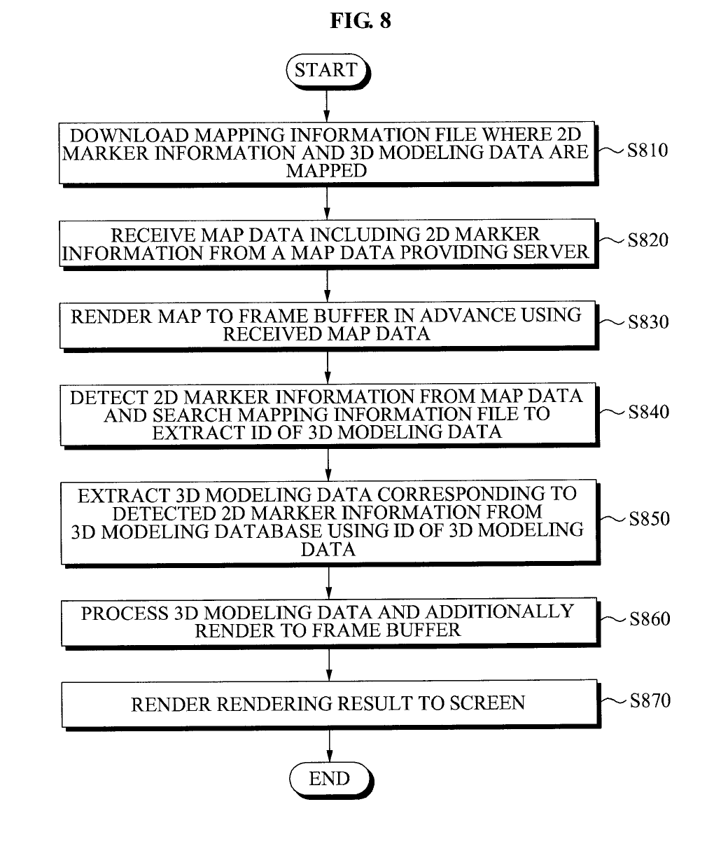

FIG. 8 is a flowchart illustrating a method for 3D web map service using augmented reality according to an example embodiment of the present invention.

Referring to FIGS. 1 to 8, a 3D web map service system 100 performs downloading of a mapping information file where 2D marker information and 3D modeling data are mapped in operation S810. Also, in operation S810, the 3D web map service system 100 may perform downloading of the 3D modeling data in advance. Also, in operation S810, the 3D web map service system 100 may record and maintain the 3D modeling data in a 3D modeling database.

In operation S820, the 3D web map service system 100 receives map data including the 2D marker information from a map data providing server 120 interworking through a network 110.

In operation S830, the 3D web map service system 100 renders a map to a frame buffer in advance using the received map data.

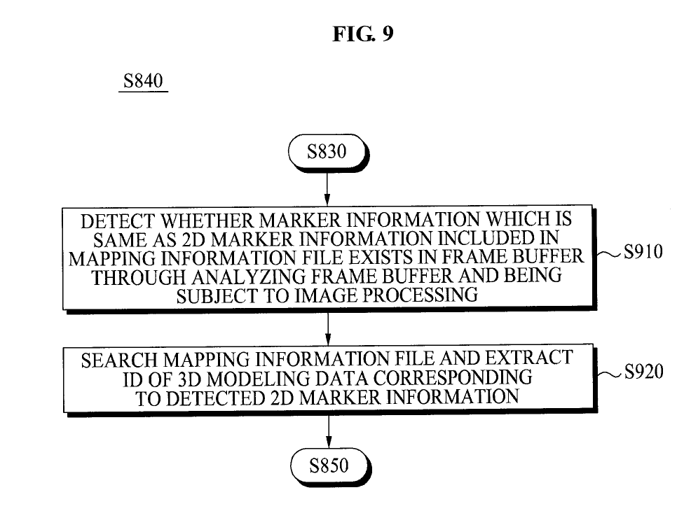

In operation S840, the 3D web map service system 100 detects the 2D marker information from the map data, and searches a mapping information file to extract an ID of the 3D modeling data. Hereinafter, detecting the 2D marker information and searching the mapping information file to extract the ID of the 3D modeling data will be described in detail referring to FIG. 9.

FIG. 9 illustrates an example that embodies an operation of extracting an ID of 3D modeling data through detecting 2D marker information and searching a mapping information file.

Referring to FIGS. 1 to 9, in operation S910, the 3D web map service system 100 detects whether marker information which is the same as the 2D marker information included in the mapping information file exists in the frame buffer through analyzing the frame buffer and being subject to an image processing.

In operation S920, the 3D web map service system 100 searches the mapping information file, and extracts an ID of the 3D modeling data corresponding to the detected 2D marker information. That is, in operation S920, the 3D web map service system 100 searches the mapping information file, and extracts the ID of the 3D modeling data corresponding to the detected 2D marker information as illustrated in FIG. 6.

In operation S850, the 3D web map service system 100 extracts 3D modeling data corresponding to the detected 2D marker information from the 3D modeling database using the ID of the 3D modeling data.

In operation S860, the 3D web map service system 100 processes the 3D modeling data and additionally renders the processed 3D modeling data to the frame buffer. That is, in operation S860, the 3D web map service system 100 renders the extracted 3D modeling data to a predetermined location through adjusting a size and rotation direction according to a distortion degree of a marker on the map.

In operation S870, the 3D web map service system 100 renders the rendered data to a screen. That is, in operation S870, as a result of rendering the 3D modeling data on the map, the 3D web map service system 100 may render a 3D map data 720 as illustrated in FIG. 7 to a screen.

As described above, the 3D map web service method may perform mapping of 2D marker information expressible with a small amount of data with a specific 3D object in advance, receive only 2D marker information corresponding to a location where the 3D object to be drawn without receiving the entire 3D object when receiving map data in real time, render 3D modeling data corresponding to the 2D marker information, and thereby can provide 3D map service.

The 3D web map service method using augmented reality according to embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method for a 3-dimensional (3D) web map service using augmented reality, the method comprising:
downloading a mapping information file where 2-dimensional (2D) marker information and 3D modeling data are mapped;
receiving map data including the 2D marker information from a map data providing server;
rendering a map to a frame buffer in advance using the received map data;
extracting an identification (ID) of the 3D modeling data through detecting 2D marker information from the map data and searching the mapping information file;
extracting the 3D modeling data corresponding to the detected 2D marker information from a 3D modeling database using the ID of the 3D modeling data;
additionally rendering the 3D modeling data to the frame buffer after processing the 3D modeling data; and
rendering the rendered data to a screen.

2. The method of claim 1, wherein the additionally rendering renders the extracted 3D modeling data to a predetermined location through adjusting a size and rotation direction according to a distortion degree of a marker on the map.

3. The method of claim 1, wherein the extracting of the ID comprises:
detecting whether marker information which is the same as the 2D marker information included in the mapping information file exists in the frame buffer through analyzing the frame buffer and being subjected to an image processing; and
extracting the ID of the 3D modeling data corresponding to the detected marker information through searching the mapping information file.

4. The method of claim 1, wherein the 2D marker information inversely calculates a direction and distance, and has a single pattern in every direction.

5. The method of claim 1, wherein the 3D modeling data includes all data used for a game or 3D rendering.

6. The method of claim 1, further comprising:
downloading the 3D modeling data in advance.

7. The method of claim 1, further comprising:
recording and maintaining the 3D modeling data and mapping file information in the 3D modeling database.

8. A computer readable recording device storing a program for implementing a method of claim 1.

9. A 3D web map service system, the system comprising:
a 3D modeling database to store a mapping information file where 2D marker information and 3D modeling data are mapped;
a receiving unit to receive map data including 2D marker information from a map data providing server;
an extractor to extract an ID of the 3D modeling data through detecting 2D marker information from the map data and searching the mapping information file, and to extract the 3D modeling data corresponding to the 2D marker information detected from the 3D modeling database using the ID of the 3D modeling data; and
a rendering unit to render a map to a frame buffer using the map data in advance, process the 3D modeling data, and additionally render the 3D modeling data to the frame buffer.

10. The system of claim 9, wherein the rendering unit renders the extracted 3D modeling data to a predetermined location through adjusting a size and rotation direction according to a distortion degree of a marker on the map.

11. The system of claim 9, wherein the extracting unit detects whether marker information which is the same as the 2D marker information included in the mapping information file exists in the frame buffer through analyzing the frame buffer and being subjected to an image processing, and extracts the 3D modeling data corresponding to the detected marker information through searching the mapping information file.

12. The system of claim 9, wherein the 3D modeling database performs downloading of the 3D modeling data in advance and stores the mapping file information generated by mapping the 3D modeling data with the 2D marker information.
